(19) United States
(12) Patent Application Publication
(10) Pub. No.: US 2017/0261393 A1
(43) Pub. Date: Sep. 14, 2017

(54) DEVICE FOR MEASURING DIFFERENTIAL PRESSURE

(71) Applicant: Valeo Systemes de Controle Moteur, Cergy Saint Christophe (FR)

(72) Inventors: Olivier GUEGUEN, Caen (FR); Piotr ZAKRZEWSKI, Acheres (FR); Nicolas GELEZ, Le Pecq (FR)

(73) Assignee: Valeo Systemes de Controle Moteur, Cergy Saint Christophe (FR)

(21) Appl. No.: 15/512,294

(22) PCT Filed: Sep. 15, 2015
(86) PCT No.: PCT/FR2015/052457

§ 371 Date: May 22, 2017

(30) Foreign Application Priority Data
Sep. 19, 2014 (FR) 1458864

(51) Int. Cl. G01L 15/00; G01L 19/08; G01L 19/14; G01L 19/06

(52) U.S. Cl. CPC G01L 15/00; G01L 19/0627; G01L 19/086; G01L 19/147

(57) ABSTRACT

This invention relates to a device for measuring differential pressure comprising a first pressure measurement means (11) measuring a first pressure value (P1) and a second pressure measurement means (12) measuring a second pressure value (P2), the second pressure measurement means (12) being configured to read the pressure (P1) measured by the first pressure measurement means (11), calculate the pressure difference between the pressure (P1) measured by the first pressure measurement means (11) and the pressure (P2) measured by the second pressure measurement means (12), and transmit the differential pressure value in the form of a single signal. The first pressure measurement means (11) is of the analogue or digital type and the second pressure measurement means (12) is of the digital type and the value of the differential pressure transmitted is in the form of a single digital signal.

This invention relates to the field of measuring differential pressure, and more particularly a device for measuring differential pressure using two pressure measurement means.

Differential pressure in a system is measured by determining the difference between two measured pressure values.

Currently, two types of devices for measuring this differential pressure are known.

A first type of device comprises a chamber in which is arranged a membrane that deforms under the action of two pressures P1 and P2, applied on either side of this membrane. The differential pressure is obtained by the difference in the pressure measurement between P1 and P2. This differential pressure is then transmitted in the form of an analogue or digital SENT signal (which stands for Single Edge Nibble Transmission) to a signal processing unit.

Another type of device uses two sensors, both of the same analogue or digital type, which each measure an absolute pressure P1 and P2. Each of these sensors then transmits, independently of the other, a signal to an electronic system. This electronic system then calculates the difference between these two absolute values and enables a differential pressure value to be obtained.

One of the drawbacks of these devices derives from the fact that they require two analogue or digital signals to be sent. Moreover, in the case of the first device, the configuration of the sensor is such that it does not allow a proper drainage of the condensates.

The aim of this invention is therefore to overcome one or more of the drawbacks of the devices of the prior art by proposing a simplified device for measuring differential pressure and enabling a better drainage of the condensates.

For this, the present invention proposes a device for measuring differential pressure comprising a first pressure measurement means measuring a first pressure value and a second pressure measurement means measuring a second pressure value, the second pressure measurement means being configured to read the pressure measured by the first pressure measurement means, calculate the pressure difference between the pressure measured by the first pressure measurement means and the pressure measured by the second pressure measurement means, and transmit the differential pressure value in the form of a single signal.

According to an embodiment of the invention, the first pressure measurement means is of the analogue or digital type and the second pressure measurement means is of the digital type.

According to an embodiment of the invention, the differential pressure value is transmitted in the form of a single digital signal.

According to an embodiment of the invention, the pressure measurement means are fixed on a support.

According to an embodiment of the invention, the support is a ceramic substrate or a printed circuit board.

According to an embodiment of the invention, the support and pressure measurement means are integrated in a casing.

According to an embodiment of the invention, the support and pressure measurement means are immersed, at least partly, in a resin.

According to an embodiment of the invention, the casing also has two openings arranged at each of the pressure measurement means.

This invention also concerns the use of the device according to the invention in a motor vehicle.

According to an embodiment, the use of the device is to monitor the emissions of particles in a motor vehicle.

According to an embodiment, the use of the device is to adjust the rate of recirculation gas in the high- and/or low-pressure recirculation loops.

This invention also concerns a method of measuring differential pressure by implementing the device according to the invention, comprising the steps of:
measuring of pressures, by the first pressure measurement means of the analogue or digital type and the second pressure measurement means of the digital type respectively,
reading the pressure measurement, measured by the first pressure measurement means of the analogue or digital type, by the second pressure measurement means of the digital type.

According to an embodiment of the invention, the differential pressure measurement method comprises the steps of:
after reading the pressure measurement, measured by the first pressure measurement means of the analogue or digital type, by the second pressure means of the digital type, calculating the pressure difference,
transmitting the differential pressure value in the form of a single digital signal to a computer.

According to another embodiment of the invention, the method comprises the steps of:
after reading the pressure measurement, measured by the first pressure measurement means of the analogue or digital type, by the second measurement means of the digital type, transmitting the pressure values in the form of a single digital signal to a computer,
calculating the differential pressure.

Other aims, characteristics and advantages of the invention will be better understood and emerge more clearly from the following description, with reference to the accompanying figures, given by way of example and in which:

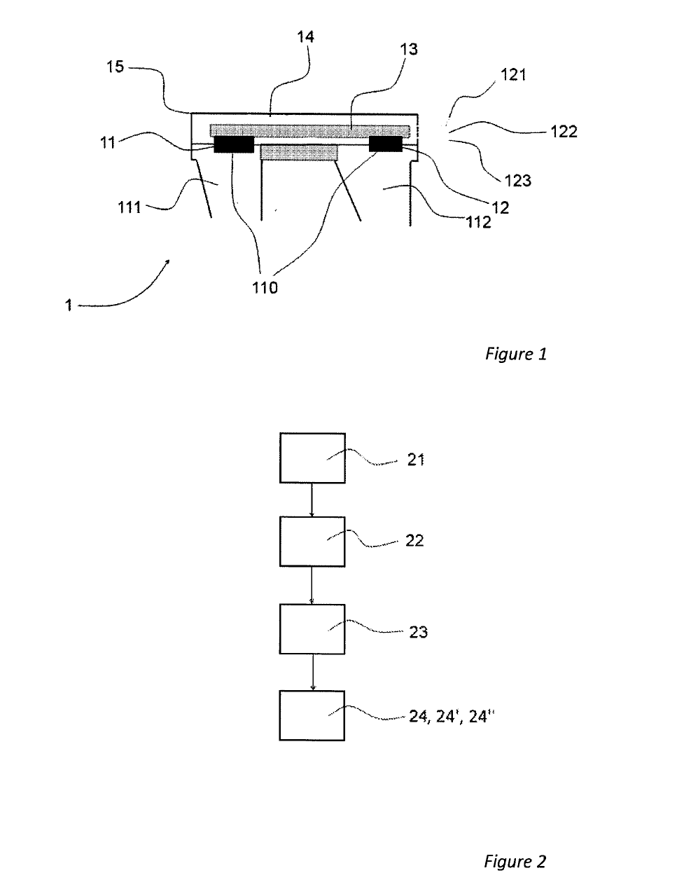

FIG. 1 is a schematic representation of the device according to the invention,

FIG. 2 is a schematic representation of the method implementing the device according to the invention.

This invention relates to a differential pressure measurement device 1 as well as the associated differential pressure measurement method. The differential pressure measurement device 1 is also called a differential pressure measurement sensor or deltaP sensor (P standing for Pressure).

The differential pressure measurement device 1 according to the invention, and shown in FIG. 1, comprises two pressure measurement means 11, 12.

According to an embodiment of the invention, the pressure measurement means 11, 12 comprise a sensitive element.

According to another embodiment of the invention, the pressure measurement means 11, 12 comprise an electrical wire.

Within the scope of the invention, a first pressure measurement means 11 is of the analogue type and a second pressure measurement means 12 is of the digital type.

According to another embodiment of the invention, a first pressure measurement means 11 is of the digital type and a second pressure measurement means 12 is of the digital type.

Within the scope of the invention, the pressure measurement means 11, 12 are fixed onto a support 13. This support is a support for electronic components.

According to an embodiment of the invention, the support 13 is a ceramic substrate.

According to a variation of the invention, the support 13 is a printed circuit board (PCB).

According to an embodiment of the invention, the support 13/pressure measurement means 11, 12 assembly is integrated in a casing 15. The support/measurement means assembly is protected by an injected resin 14. The presence of resin protects and seals the device 1. The support/pressure measurement means assembly is thus immersed in the resin 14 in the casing 15. The support 13 is totally immersed in the resin 14 in the casing 15. The support 13 is totally immersed in the resin 14. The pressure measurement means 11, 12 are partially immersed in the resin 14 so as to allow contact with the fluid of which the pressure is measured.

Each of these pressure measurement means 11, 12 is brazed onto the printed circuit board or ceramic support, held by support points and welded, for example, onto an electrical connection tab in the casing 15 of the differential pressure measurement device.

The casing 15 also comprises two openings 111, 112 arranged at each of the pressure measurement means 11, 12. The openings 111, 112 are arranged at the part 110 of the measurement means 11, 12 that is not immersed in the resin 14. According to an embodiment of the invention, these openings 111, 112 are each formed by a duct, shown in FIG. 1, leading into the casing 15. It is through these ducts that the fluid of which the pressure is measured arrives.

Each pressure measurement means 11, 12 can thus measure a pressure. t is no longer necessary, as in the prior art, to have a circulation space on either side of the pressure measurement means to measure pressures. The absence of this space thus prevents the accumulation of fluid or liquid or gaseous condensates that lead to degradations of the differential pressure measurement device or obstructions.

Pressure measurement device 1 according to the invention allows a pressure difference to be calculated over a wide pressure range, preferably over a pressure range ranging from 10 to 400 kPa.

The measurement is thus made with the aid of pressure measurement means 11 of the analogue or digital type, for pressure P1, and of pressure measurement means 12 of the digital type, for pressure P2. Thus the pressure measurement means 12 of the digital type measures a pressure P2 and reads the pressure P1 obtained by the pressure measurement means of the analogue or digital type P1. This information is then transmitted in a single digital signal according to the SENT SAE J2716 protocol to the computer.

According to an embodiment of the invention, the information transmitted by the digital signal is pressure P1 and pressure P2, the differential pressure being calculated subsequently.

According to another embodiment of the invention, the information transmitted by the digital signal is the differential pressure corresponding to the pressure difference between P1 and P2 determined by the second pressure measurement means 12.

According to an embodiment of the invention, the information transmitted by the digital signal is the pressure values P1 and P2, and the differential pressure value between P1 and P2.

According to an embodiment of the invention, not shown, the cable connecting the differential pressure measurement device to the computer comprises three single strands. One strand is used for the transmission of data, one strand to power the device and one strand serving as an earth.

The fact of transmitting one signal instead of two thus saves on the transmission strand. Moreover, it is not necessary to use shielded or twisted lines because digital signals are fault-tolerant.

The invention also concerns a differential pressure measurement method, shown in FIG. 2. The measurement of this differential pressure is performed by measuring 21 pressures P1 and P2, by the first analogue or digital pressure measurement means 11 and the second digital means 12 respectively. The second measurement means of the digital type reads 22 the value P1 measured by the first pressure measurement means of the digital or analogue type.

According to an embodiment of the invention, the second measurement means of the digital type calculates 23 the pressure difference between P1 and P2. The result of the differential pressure measurement is then transmitted 24 in the form of a single digital signal to a computer according to the SENT SAE J2716 protocol.

According to an embodiment of the invention, the second measurement means of the digital type transmits 24′ the pressure values P1 and P2 in the form of a single digital signal to a calculator according to the SENT SAE J2716 protocol.

According to another embodiment of the invention, the second measurement means of the digital type transmits 24″ the pressure values P1 and P2 and the pressure difference between P1 and P2 in the form of a single digital signal to a computer according to the SENT SAE J2716 protocol.

The measurement device 1 according to the invention is used particularly to measure differential pressure in the case:
of monitoring particle emissions to enable their regeneration,
of adjusting the rates of recirculation gas in the high and/or low pressure recirculation loops.

The scope of this invention is not limited to the details given above and allows embodiments under numerous other specific forms without departing from the field of application of the invention. Consequently, these embodiments must be regarded as being illustrative and can be changed without, however, departing from the scope defined by the claims.

1. A device for measuring differential pressure comprising:
a first pressure measurement means measuring a first pressure value; and
a second pressure measurement means measuring a second pressure value, the second pressure measurement means being configured to:
read the pressure measured by the first pressure measurement means,
calculate the pressure difference between the pressure measured by the first pressure measurement means and the pressure measured by the second pressure measurement means, and
transmit the differential pressure value in the form of a single signal, the first pressure measurement means being of the analogue or digital type and the second pressure measurement means being of the digital type.

2. The device according to claim 1, wherein the differential pressure value is transmitted in the form of a single digital signal.

3. The device according to claim 1, wherein the pressure measurement means are fixed on a support.

4. The device according to claim 3, wherein the support is a ceramic substrate or a printed circuit board.

5. The device according to claim 3, wherein the support and pressure measurement means are integrated in a casing.

6. The device according to claim 3, wherein the support and the pressure measurement means are immersed, at least partly, in a resin.

7. The device according to claim 5, wherein the casing also has two openings arranged at each of the pressure measurement means.

8. The device according to claim 1, wherein the device is used in a motor vehicle.

9. The device according to claim 1, wherein the device is used for monitoring the emissions of particles in a motor vehicle.

10. The device according to claim 1, wherein the device is used to adjust the rate of recirculation gas in high- and/or low-pressure recirculation loops.

11. A method of measuring differential pressure by implementing the device according to claim 1, comprising:
measuring of a first and a second pressures, by the first pressure measurement means of the analogue or digital type and the second pressure measurement means of the digital type respectively; and
reading the first pressure measurement, measured by the first pressure measurement means of the analogue or digital type, by the second pressure measurement means of the digital type.

12. The differential pressure measurement method according to claim 11, further comprising:
after reading the first pressure measurement, measured by the first pressure measurement means of the analogue or digital type, by the second pressure means of the digital type, calculating a pressure difference between the first pressure measurement and the second pressure measurement; and
transmitting the differential pressure value in the form of a single digital signal to a computer.

13. The differential pressure measurement method according to claim 11, further comprising:
after reading the first pressure measurement, measured by the first pressure measurement means of the analogue or digital type, by the second measurement means (12) of the digital type, transmitting the a value of the first pressure measurement and a value of the second pressure measurement in the form of a single digital signal to a computer; and
calculating a differential pressure between the first and the second pressure values.
